(19) United States
(12) Patent Application Publication
(10) Pub. No.: US 2014/0100806 A1
(43) Pub. Date: Apr. 10, 2014

(54) METHOD AND APPARATUS FOR MATCHING TOOLS BASED ON TIME TRACE DATA

(71) Applicant: GLOBALFOUNDRIES INC., Grand Cayman (KY)

(72) Inventors: Richard P. Good, Radebeul (DE); Thorsten Schepers, Dresden (DE)

(73) Assignee: GLOBALFOUNDRIES INC., Grand Cayman (KY)

(21) Appl. No.: 13/644,788

(22) Filed: Oct. 4, 2012

(51) Int. Cl. G01N 37/00; G06F 19/00

(52) U.S. Cl. 702/82

(57) ABSTRACT

A method includes receiving tool trace data from a group of tools of the same type in a computing device. A tool fingerprint is generated for each tool using the tool trace data for the tools in group other than the tool for which the tool fingerprint is generated in the computing device. A tool score is generated for each tool based on its tool trace data and its associated fingerprint in the computing device. A fault condition with at least a selected tool is identified based on the tool scores in the computing device.

### CROSS-REFERENCE TO RELATED APPLICATIONS

Not applicable.

### BACKGROUND

The disclosed subject matter relates generally to the field of semiconductor device manufacturing and, more particularly, to a method and apparatus for matching tools based on time trace data.

There is a constant drive within the semiconductor industry to increase the quality, reliability and throughput of integrated circuit devices, e.g., microprocessors, memory devices, and the like. This drive is fueled by consumer demands for higher quality computers and electronic devices that operate more reliably. These demands have resulted in a continual improvement in the manufacture of semiconductor devices, e.g., transistors, as well as in the manufacture of integrated circuit devices incorporating such transistors. Additionally, reducing the defects in the manufacture of the components of a typical transistor also lowers the overall cost per transistor as well as the cost of integrated circuit devices incorporating such transistors.

Generally, a set of processing steps is performed on a wafer, individual die on the wafer, and/or on discrete die using a variety of process tools, including photolithography steppers, etch tools, deposition tools, polishing tools, rapid thermal process tools, implantation tools, test equipment tools, etc. One technique for improving the operation of a semiconductor processing line includes using a factory wide control system to automatically control the operation of the various process tools. The manufacturing tools communicate with a manufacturing framework or a network of processing modules. Each manufacturing tool is generally connected to an equipment interface. The equipment interface is connected to a machine interface which facilitates communications between the manufacturing tool and the manufacturing framework. The machine interface can generally be part of an advanced process control (APC) system. The APC system initiates a control script based upon a manufacturing model, which can be a software program that automatically retrieves the data needed to execute a manufacturing process. Often, semiconductor devices are staged through multiple manufacturing tools for multiple processes, generating data relating to the quality of the processed semiconductor devices. Pre-processing and/or post-processing metrology data is supplied to process controllers for the tools. Operating recipe parameters are calculated by the process controllers based on the performance model and the metrology information to attempt to achieve post-processing results as close to a target value as possible. Reducing variation in this manner leads to increased throughput, reduced cost, higher device performance, etc., all of which equate to increased profitability.

At a given process step, one or more process tools of the same type may be available for performing the required processing. Although the various tools are capable of performing the same process on the lot, the tools may not be operating at the same level of proficiency (i.e., tool health). For example, one tool may be operating near the end of an interval between cleaning cycles. In some instances, when a tool is nearer the end of its cleaning interval the wafers processed in the tool may exhibit a higher particle contamination rate, as compared to a tool operating nearer the front end of its cleaning interval. A higher particle contamination rate can degrade the grade or yield of the wafers processed in the tool.

Given the disparities across the process tools for a given step, it is useful to keep the equipment matched (including all chambers, and sub-chambers) to ensure consistent yields. One approach to matching the process tools involves looking at the measurements on the wafer after running the tool, not the sensors on the tool itself. For example, chambers may be matched using inline metrology data such as critical dimensions (CDs) or layer thicknesses. Such inline data does not completely capture the operation of the equipment and yield-relevant mismatches can still exist. Another approach using sensor time series data from all tools and chambers and looking for statistical outliers using automated or automatic data review. In such an approach, mismatches must be typically large before they are detected statistically and a large amount of data is required for the approach to be used. Manual review techniques require a tremendous amount of human resources, hence only a very few sensors on very few tools can be monitored and the chamber matching is subjective.

This section of this document is intended to introduce various aspects of art that may be related to various aspects of the disclosed subject matter described and/or claimed below. This section provides background information to facilitate a better understanding of the various aspects of the disclosed subject matter. It should be understood that the statements in this section of this document are to be read in this light, and not as admissions of prior art. The disclosed subject matter is directed to overcoming, or at least reducing the effects of, one or more of the problems set forth above.

### BRIEF SUMMARY OF EMBODIMENTS

The following presents a simplified summary of only some aspects of embodiments of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

One aspect of the disclosed subject matter is seen in a method that includes receiving tool trace data from a group of tools of the same type in a computing device. A tool fingerprint is generated for each tool using the tool trace data for the tools in group other than the tool for which the tool fingerprint is generated in the computing device. A tool score is generated for each tool based on its tool trace data and its associated fingerprint in the computing device. A fault condition with at least a selected tool is identified based on the tool scores in the computing device.

Another aspect of the disclosed subject matter is seen in a manufacturing system including a plurality of tools for processing a plurality of manufactured items in a process flow and a tool monitor. The tool monitor is configured to receive tool trace data from a group of tools of the same type in a computing device, generate a tool fingerprint for each tool using the tool trace data for the tools in group other than the tool for which the tool fingerprint is generated in the computing device, generate a tool score for each tool based on its tool trace data and its associated fingerprint in the computing device, and identify a fault condition with at least a selected tool based on the tool scores in the computing device.

### BRIEF DESCRIPTION OF THE SEVERAL VIEWS OF THE DRAWINGS

The disclosed subject matter will hereafter be described with reference to the accompanying drawings, wherein like reference numerals denote like elements, and:

FIG. 1 is a simplified block diagram of a manufacturing system in accordance with one illustrative embodiment of the present subject matter;

FIG. 2 is a diagram illustrating an exemplary tool fingerprint used by a tool monitor in the system of;

FIG. 3 is a diagram illustrating the calculated error components across a time series using the fingerprint of FIG. 2; and

FIGS. 4-7 are diagrams illustrating tool score reports generated by the tool monitor of FIG. 2.

While the disclosed subject matter is susceptible to various modifications and alternative forms, specific embodiments thereof have been shown by way of example in the drawings and are herein described in detail, It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

One or more specific embodiments of the disclosed subject matter will be described below. It is specifically intended that the disclosed subject matter not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the disclosed subject matter unless explicitly indicated as being “critical” or “essential.”

The disclosed subject matter will now be described with reference to the attached figures. Various structures, systems and devices are schematically depicted in the drawings for purposes of explanation only and so as to not obscure the disclosed subject matter with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

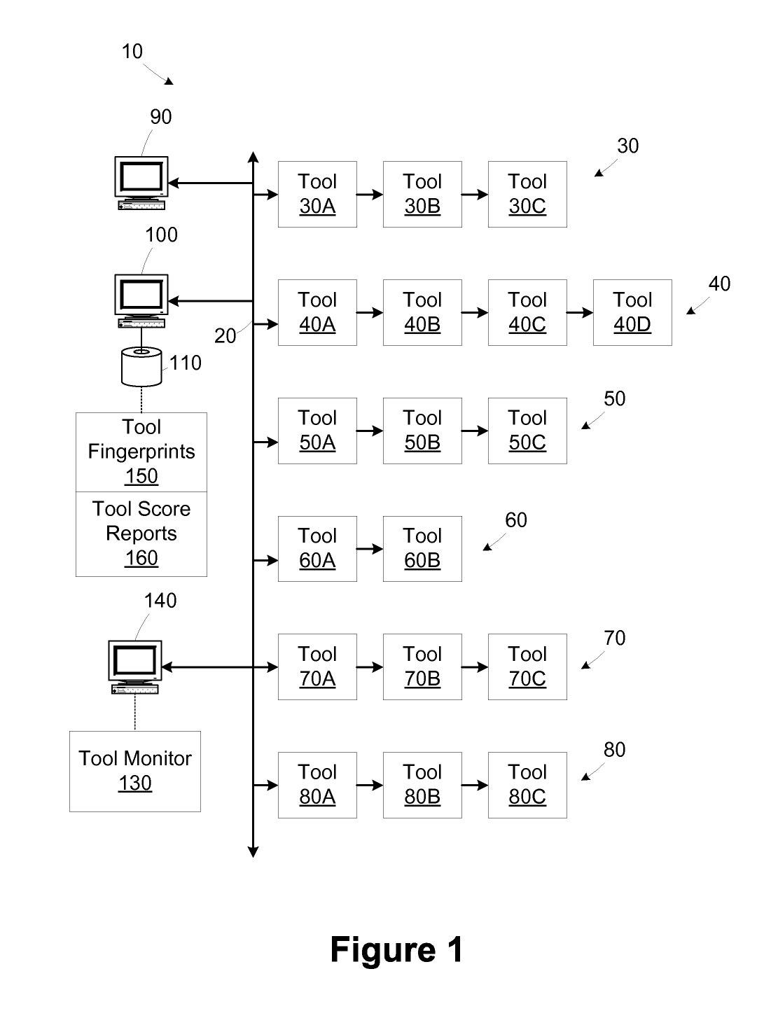

Referring now to the drawings wherein like reference numbers correspond to similar components throughout the several views and, specifically, referring to FIG. 1, the disclosed subject matter shall be described in the context of an illustrative manufacturing system 10.

In the illustrated embodiment, the manufacturing system 10 is adapted to fabricate semiconductor devices. Although the subject matter is described as it may be implemented in a semiconductor fabrication facility, the application of the techniques described herein is not so limited and may be applied to other manufacturing environments. The techniques described herein may be applied to a variety of manufactured items including, but not limited to microprocessors, memory devices, digital signal processors, application specific integrated circuits (ASICs), or other similar devices. The techniques may also be applied to manufactured items other than semiconductor devices.

A network 20 interconnects various components of the manufacturing system 10, allowing them to exchange information. The illustrative manufacturing system 10 includes a plurality of tools 30-80. Each of the tools 30-80 may be coupled to a computer (not shown) for interfacing with the network 20. The tools 30-80 are grouped into sets of tools of the same type, as denoted by lettered suffixes. For example, the set of tools 30A-30C represent tools of a certain type, such as a photolithography stepper that are capable of performing the same process operation. In the case of tools 30-80 with multiple chambers, the lettered suffixes may represent multiple chambers of a single process tool. A particular wafer or lot of wafers progresses through the tools 30-80 as it is being manufactured, with each tool 30-80 performing a specific function in the process flow. Exemplary process tools for a semiconductor device fabrication environment, include metrology tools, photolithography steppers, etch tools, deposition tools, polishing tools, rapid thermal process tools, implantation tools, test equipment tools, etc. The tools 30-80 are illustrated in a rank and file grouping for illustrative purposes only, In an actual implementation, the tools may be arranged in any order of grouping. Additionally, the connections between the tools in a particular grouping are meant to represent only connections to the network 20, rather than interconnections between the tools.

Although the invention is described as it may be implemented for scheduling lots of manufactured items, it may also be used schedule individual manufactured items.

A manufacturing execution system (MES) server 90 directs the high level operation of the manufacturing system 10. The MES server 90 monitors the status of the various entities in the manufacturing system 10 (i.e., lots, tools 30-80) and controls the flow of articles of manufacture (e.g., lots of semiconductor wafers) through the process flow. The MES server 90 may also be referred to as a scheduling server. A database server 100 is provided for storing data related to the status of the various entities and articles of manufacture in the process flow. The database server 100 may store information in one or more data stores 110. The data may include pre-process and post-process metrology data, tool trace data, lot priorities, etc. The manufacturing system 10 also includes a tool monitor 130 executing on a workstation 140. As described in greater detail below, the tool monitor 130 monitors trace data from the tools 30-80 to identify mismatches between grouped tools 30-80. The distribution of the processing and data storage functions amongst the different computers or workstations in FIG. 1 is generally conducted to provide independence and central information storage. Of course, different numbers of computers and different arrangements may be used. An exemplary information exchange and process control framework suitable for use in the manufacturing system 10 is an Advanced Process Control (APC) framework.

Portions of the invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

In the illustrated embodiment, the tool monitor 130 uses tool fingerprinting and leave one out cross-validation to match tools 30-80 and identify a fault situation. To fingerprint the tools 30-80, a tool fingerprint 150, also referred to as a tool model, is created for the tools 30-80 using tool sensor data for all tools in a particular group except the selected tool 30-80 being scored. For example, if there are ten tools 30-80 of the same type in a particular group (i.e., capable of performing the same process operation), ten tool fingerprints 150 are generated, each incorporating sensor data from the nine other tools 30-90. By leaving out the selected tool 38-80 being scored, its data does not factor into the control limits being generated in the tool fingerprint 150. The particular sensors for which tool fingerprints 150 are created may vary. Exemplary tool trace sensor variables include temperatures, pressures, gas flows, voltages, electrical current, electromagnetic frequencies, distances, and wafer reflectivity. The tool fingerprints 150 may be based on data for a single sensor over the tools 30-80 in the group, or multiple tool sensor values may be combined in a multivariate fingerprint.

In one embodiment, the tool fingerprints 150 are generated using mean and standard deviation. The mean and standard deviation of a tool sensor value at a plurality of time instants across multiple process runs of the tools 30-80 in the group is computed to generate time series control limits. The number of process runs used to generate the tool fingerprint 150 may vary, but generally, the tool fingerprint is generated using data from recent runs (e.g., a sample of wafers from the previous week) to provide matching according to the current state of the tools 30-80. A fault threshold may be set at 6a and a warning threshold may be set at 3a in an exemplary embodiment. After a tool fingerprint 150 is generated, the sensor values for the selected tool 30-80 that was not used to generate the fingerprint 150 is compared to the time series fingerprint 150. The score for the selected tool 30-80 is generated by comparing the time series sensor values of the selected tool 30-80 to the fault and warning thresholds established by the fingerprint 150. The scores for each time instance in the time series may be aggregated using a root mean square (RMS) time series technique, where i represents a time series sample point, N is the number of time samples in the trace, yᵢ represents the sensor value from the selected tool 30-80 being scored at the time series sample point, ŷᵢ represents the mean of the tool fingerprint 150 at the time series sample point, and 3σᵢ represents the warning threshold defined in the tool fingerprint 150 at the time series sample point.

$$Tool RMS Fault ( Score ) = \sqrt{\frac{1}{N} {\sum }_{i = 0}^{N - 1} {( \frac{{y}_{i} - {\hat{y}}_{i}}{3 {σ}_{i}} )}^{2}}$$

Faults and warning levels may be defined by the same equation by defining the warning threshold as a score of 1.0 and the fault threshold as a score of 2.0. Therefore, rather than performing separate calculations, one or more warning levels may be defined based on the magnitude of the fault score.

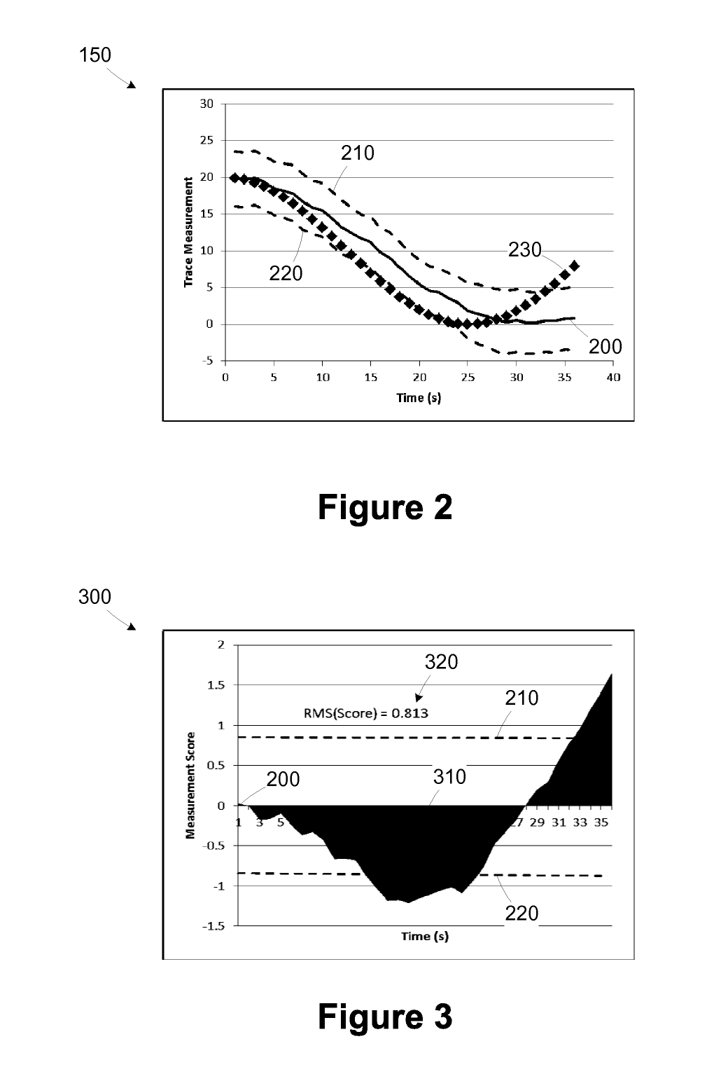

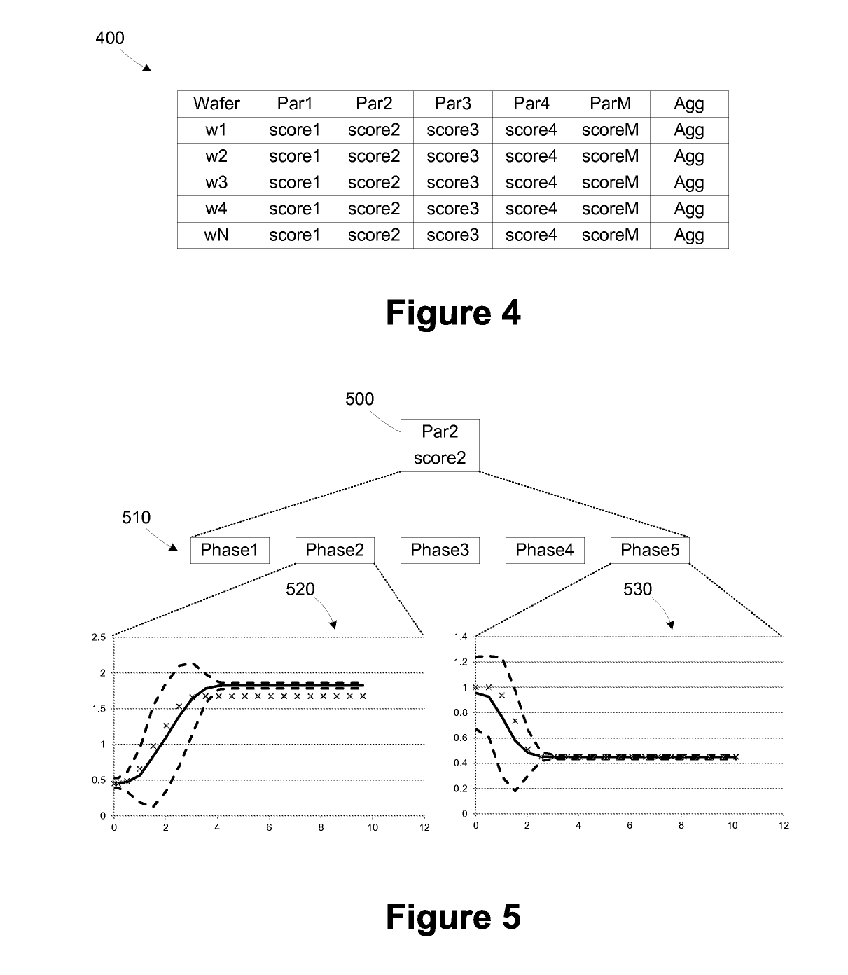

FIG. 2 is a diagram illustrating an exemplary tool fingerprint 150. Curve 200 represents the mean value of the tool fingerprint 150 across multiple time instants. Curve 210 represents an upper control limit of the tool fingerprint 150 (e.g., +3σᵢ). Curve 220 represents a lower control limit of the tool fingerprint 150 (e.g., −3σᵢ). Curve 230 represents the tool trace data of the selected tool 30-80 being scored. FIG. 3 is an error diagram illustrating the calculated RMS components 310 across the time series, resulting in an aggregate RMS score 320.

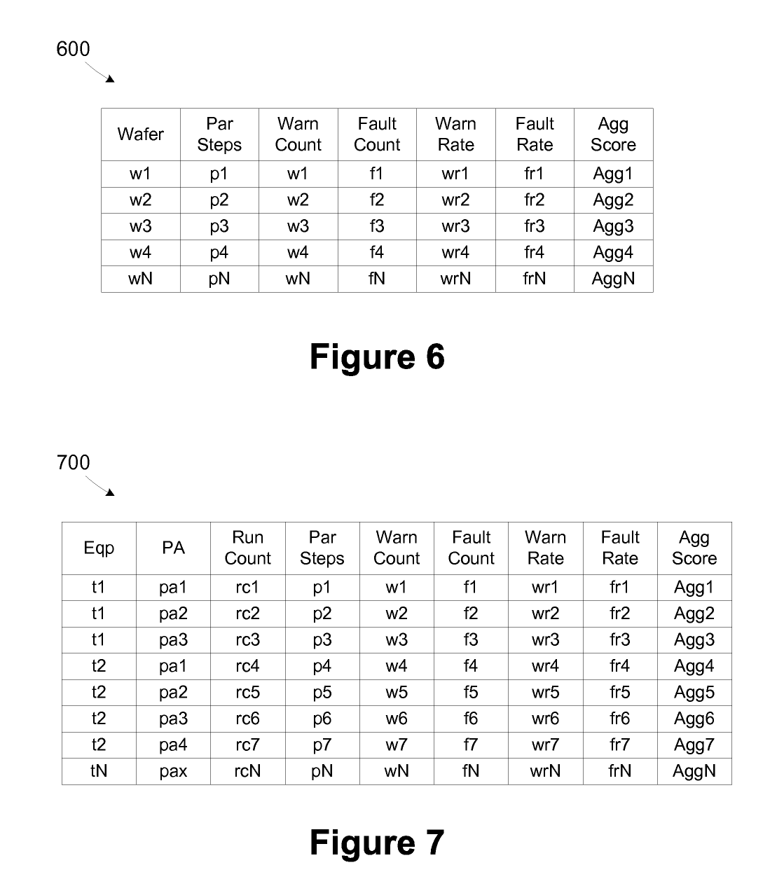

Based on the tool scores, various tool score reports 160 may be generated. An exemplary tabular report 400 is illustrated in FIG. 4. The report 400 provides individual parameter results at the wafer level. For a particular run of a selected tool 30-80, a separate tool fingerprint 150 is generated for each parameter (Par1-M), and each trace for the selected tool 30-80 is compared to the fingerprints 150 to generate a plurality of tool scores for the run. The scores for the run may be linked to the wafer (w1-N) or lot processed during the run. The aggregate or average of the tool parameter scores (Agg) may be computed and used as another indicator of the performance of the tool 30-80 during the run for the wafer. For example, warning and fault thresholds may be determined for each tool parameter as well as for the aggregate parameter. Different colors may be used to flag potential problems indicated by the particular scores.

A user may select a particular score to see increased detail regarding the score. In some cases a particular tool score for a parameter may also be an aggregate. A process run may include multiple phases. For example, in a deposition tool 30-80, one parameter monitored during a process run is heater lift current distance, which is the distance measured by the tool between the heating element and the wafer being processed. The process run typically includes a pump step to purge the chamber, a pre-step cleaning step to prepare the wafer surface, a deposition step, a stabilization step (STAB) to stabilize the chamber, and a second stabilization step for stabilizing the octamethylcyclotetrasiloxane (OMCTS) gas flow rate (STAB OMCTS). Each step may be fingerprinted separately, and a step score for each step may be calculated. An aggregate parameter score may be determined for the run by averaging the step scores. The parameter score for the parameter may be the aggregate step score. For example, parameter 2 may be an aggregate parameter. If the aggregate step score is suspect, a user may select the score to drill down further in the data, as illustrated in FIG. 6. FIG. 6 illustrates the data hierarchy for the Par2 data 500. The individual step scores 510 (Step1-5) for the parameter may be displayed. The user may select a Step score 510 to see the time series data 520, 530 for the parameter during the particular step.

FIG. 6 illustrates a wafer level summary table 600. The data columns include Wafer ID, Parameters Steps representing the number of parameters measured during the run, Warning Count representing the number of parameters flagged with a warning, Fault Count representing the number of parameters flagged with a fault, Warning Fault Rate representing the percentage of parameters having a warning, Fault Rate representing the percentage of parameters having a fault, and an Aggregate Score.

FIG. 7 illustrates an equipment level summary table 700. The data columns include Equipment ID, PA representing a chamber in the tool, Run Count representing the number of runs for the tool/chamber, Parameters Steps representing the number of parameters for the tool/chamber measured across the number of runs, Warning Count representing the number of parameters flagged with a warning, Fault Count representing the number of parameters flagged with a fault, Warning Fault Rate representing the percentage of parameters having a warning, Fault Rate representing the percentage of parameters having a fault, and an Aggregate Score.

The tool score techniques described herein are process agnostic and scalable. Aggregate scores may be used at various levels for different parameters and phases of a process run. The tool score reports 160 may be presented at different levels to allow problems to be identified at a summary level, and the reports 160 may be focused to show the results for a particular parameter, a particular run, or a particular phase.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

We claim:

1. A method, comprising:
receiving tool trace data from a group of tools of the same type in a computing device;
generating a tool fingerprint for each tool using the tool trace data for the tools in group other than the tool for which the tool fingerprint is generated in the computing device;
generating a tool score for each tool based on its tool trace data and its associated fingerprint in the computing device; and
identifying a fault condition with at least a selected tool based on the tool scores in the computing device.

2. The method of claim 1, wherein the tool trace data comprises time series data, generating each tool fingerprint comprises generating a mean and a standard deviation of the plurality of tool trace data for the tools in group other than the tool for which the tool fingerprint is generated at a plurality of time instances in the time series data, and generating the tool score for a selected tool in the group comprises generating an error metric at each time of the instances and aggregating the error metrics across the time series data.

3. The method of claim 1, wherein generating the tool score for a selected tool in the group comprises generating a root mean square error metric using the fingerprint for a selected tool and the tool trace data for the selected tool.

4. The method of claim 1, further comprising generating a report including the tool scores.

5. The method of claim 4, wherein the tools are operable to process semiconductor wafers, the tool trace data comprises data from multiple parameters, and the method further comprises:
generating a tool fingerprint for each parameter for each tool using the tool trace data for the tools in group other than the tool for which the tool fingerprint is generated; and
generating a tool score for each parameter for each tool based on its tool trace data and its associated fingerprint.

6. The method of claim 5, further comprising generating a report including tool scores for the multiple parameters indexed by the semiconductor wafers.

7. The method of claim 5, further comprising generating a report including tool scores for the multiple parameters indexed by the tools.

8. The method of claim 5, further comprising generating an aggregate score using the plurality of tool scores for the multiple parameters.

9. The method of claim 1, wherein the tool trace data comprises a plurality of phases, generating the tool fingerprint for each tool comprises generating a phase fingerprint for each of the phases, and generating the tool score for each tool comprises generating a phase tool score for each of the phases.

10. The method of claim 9, further comprising generating an aggregate score using the plurality of phase tool scores.

11. A manufacturing system, comprising:
a plurality of tools for processing a plurality of manufactured items in a process flow; and
a tool monitor configured to receive tool trace data from a group of tools of the same type in a computing device, generate a tool fingerprint for each tool using the tool trace data for the tools in group other than the tool for which the tool fingerprint is generated in the computing device, generate a tool score for each tool based on its tool trace data and its associated fingerprint in the computing device, and identify a fault condition with at least a selected tool based on the tool scores in the computing device.

12. The system of claim 11, wherein the tool trace data comprises time series data, and the tool monitor is operable to generate a mean and a standard deviation of the plurality of tool trace data for the tools in group other than the tool for which the tool fingerprint is generated at a plurality of time instances in the time series data, generate an error metric at each time of the instances, and aggregate the error metrics across the time series data to generate the tool score.

13. The system of claim 11, wherein the tool monitor is operable to generate a root mean square error metric using the fingerprint for a selected tool and the tool trace data for the selected tool.

14. The system of claim 11, wherein the tool monitor is operable to generate a report including the tool scores.

15. The system of claim 14, wherein the tools are operable to process semiconductor wafers, the tool trace data comprises data from multiple parameters, and the tool monitor is operable to generate a tool fingerprint for each parameter for each tool using the tool trace data for the tools in group other than the tool for which the tool fingerprint is generated and generate a tool score for each parameter for each tool based on its tool trace data and its associated fingerprint.

16. The system of claim 15, wherein the tool monitor is operable to generate a report including tool scores for the multiple parameters indexed by the semiconductor wafers.

17. The system of claim 15, wherein the tool monitor is operable to generate a report including tool scores for the multiple parameters indexed by the tools.

18. The system of claim 15, wherein the tool monitor is operable to generate an aggregate score using the plurality of tool scores for the multiple parameters.

19. The system of claim 11, wherein the tool trace data comprises a plurality of phases, and the tool monitor is operable to generate the tool fingerprint for each tool comprises generating a phase fingerprint for each of the phases and generate a phase tool score for each of the phases.

20. The system of claim 19, wherein the tool monitor is operable to generate an aggregate score using the plurality of phase tool scores.

21. A non-transitory program storage device programmed with instructions, that when executed by a computing device, perform a method comprising:
receiving tool trace data from a group of tools of the same type;
generating a tool fingerprint for each tool using the tool trace data for the tools in group other than the tool for which the tool fingerprint is generated;
generating a tool score for each tool based on its tool trace data and its associated fingerprint; and
identifying a fault condition with at least a selected tool based on the tool scores.
